(19) United States
(12) Patent Application Publication
(10) Pub. No.: US 2003/0064714 A1
(43) Pub. Date: Apr. 3, 2003

(54) Consolidated in-flight entertainment electronic system

(76) Inventors: William C. Sanford, Mukilteo, WA (US); Joseph P. Condon, Mukilteo, WA (US)

Correspondence Address: Mark D. Elchuk, Kelly K. Burris, Harness, Dickey & Pierce, P.L.C., 5445 Corporate Drive, Suite 400, Troy, MI, 48098-2683, US

(21) Appl. No.: 09/969,413

(22) Filed: Oct. 2, 2001

(51) Int. Cl. H04M 3/42

(52) U.S. Cl. 455/414; 455/422; 455/66

(57) ABSTRACT

A consolidated in-flight entertainment system is provided that comprises a server in communication with a controller switch that manages and distributes in-flight entertainment data to a plurality of components on a mobile platform, e.g. passenger seats on a commercial aircraft. The server receives, transmits, and stores in-flight entertainment data and further executes functional elements such as audio, video, and data storage, web caching and storage, component mapping, CD and DVD players, or pre-recorded announcement machine boarding music, among others, through software. Additionally, the controller switch performs certain data functions such as satellite data interfacing, multiplexing, mapping, and multimedia routing, also through software, for the efficient transfer of in-flight entertainment data to and from the server and passenger seats.

### FIELD OF THE INVENTION

The present invention relates generally to in-flight entertainment systems more particularly to systems that manage and distribute a variety of in-flight entertainment data to a plurality of components or passenger seats onboard a commercial aircraft.

### BACKGROUND OF THE INVENTION

An increasing number of commercial aircraft are providing in-flight entertainment systems for passengers and crew that include, for example, cabin displays for pre-flight safety information or in-flight movies, seatback telephones, audio jacks, and general video and audio data services such as e-mail, web access, and bi-directional data flow to/from passengers. The functional elements that support in-flight entertainment systems may include, by way of example, audio, video, and data storage, telephone system communications, CD (compact disc) and DVD (digital versatile/video disc) players, and pre-recorded announcement machine boarding music, among others. As a result, in-flight entertainment systems require additional systems that must be integrated onboard the commercial aircraft.

Unfortunately, current in-flight entertainment systems require a separate electronic box or LRU (line replaceable unit) for each functional element, i.e. a hardware-based solution, which results in additional volume and weight, along with increased power and cooling requirements onboard the aircraft. Additionally, the electronic boxes that perform certain functional elements are typically not “plug and play” compatible and must be replaced in their entirety to accommodate product upgrades. (Generally, “plug and play” refers to easy and robust connectivity among stand-alone devices and PCs (personal computers) from many different vendors). Furthermore, the electronic boxes often use different communication protocols and are not compatible when intermixed with other electronic boxes.

The individual electronic boxes are typically located within an in-cabin purser workstation (PSW) or video control center (VCC), which houses approximately ninety (90) percent of the electronics, file servers, tape decks, CD decks, controllers, and other related elements associated with in-flight entertainment, communication, and passenger service systems. As a result, the VCC consumes revenue space that could otherwise be used for additional seats or passenger comfort features, among others, in order to provide in-flight entertainment and communication services.

Accordingly, there remains a need in the art for a consolidated in-flight entertainment system that combines the functional elements of individual electronic boxes into an integrated system that reduces volume and cost, along with reducing power and cooling requirements. A need further exists for a consolidated in-flight entertainment system that is plug and play compatible and that is easily upgraded without continual replacement of individual electronic boxes. Further, a need exists for an in-flight entertainment system that is software-based rather than hardware-based to facilitate ease of upgrades and system compatibility.

### SUMMARY OF THE INVENTION

In one preferred form, the present invention provides an electronic architecture for mobile entertainment systems, e.g. in-flight entertainment systems onboard commercial aircraft, that comprises a server in communication with a controller switch that controls the transmission of mobile entertainment data, e.g. in-flight entertainment data, to a plurality of passenger seats and components. Advantageously, functional elements and data function of the in-flight entertainment system are executed from the server and the controller switch through software, and the server and controller switch are preferably located within the electronics equipment (EE) bay of an aircraft rather than within separate electronic boxes. Accordingly, significant additional space is made available for revenue generating seats or passenger comfort features. Further, the in-flight entertainment system may be upgraded through software rather than rewiring the aircraft or replacing individual electronic boxes.

Generally, the server executes a plurality of functional elements through software, wherein the functional elements comprise audio, video, and data storage, web caching and storage, component mapping, CD and DVD players, and pre-recorded announcement machine boarding music, among others. Similarly, the controller switch performs certain data functions, also through software, that comprise transmit and receive to and from a plurality of users, built in test equipment dataload, satellite data interface, multiplexing, mapping, zone standard client support service interface, packet switching system data processing, multimedia routing, and avionics data standard interface, among others.

Accordingly, a consolidated in-flight entertainment system is provided that reduces space and cost, and which further reduces power and cooling requirements onboard commercial aircraft. Further, the electronic architecture allows for plug and play compatibility in addition to ease of upgrades, which results in significant cost savings for an in-flight entertainment system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an electronic architecture for mobile entertainment systems.

### DETAILED DESCRIPTION OF THE PREFERRED EMBODIMENT

The following description of the preferred embodiments is merely exemplary in nature and is in no way intended to limit the invention, its application, or uses.

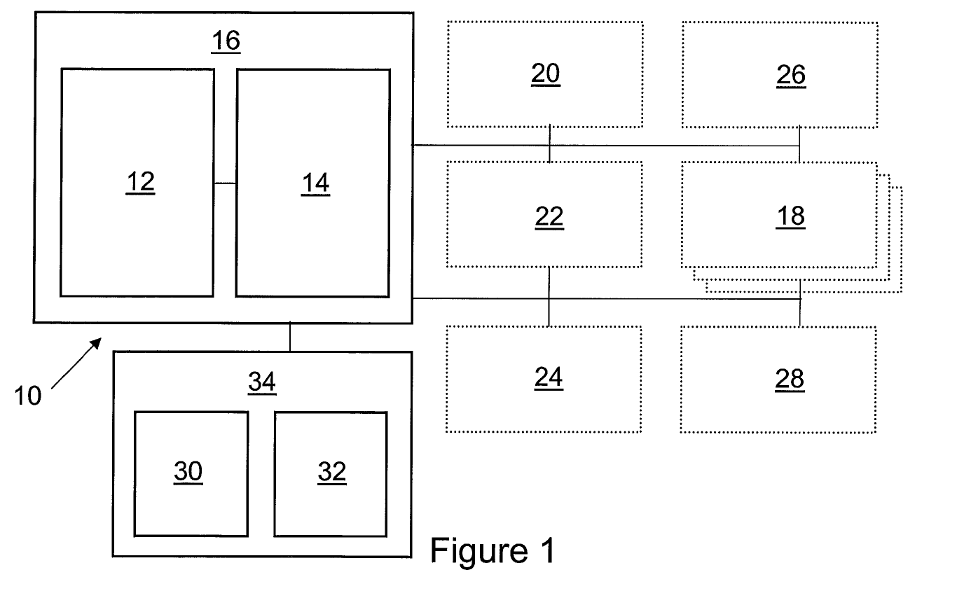

Referring to the drawing, one embodiment of an electronic architecture for mobile entertainment systems is illustrated and generally indicated by reference numeral 10 in FIG. 1. As shown, the electronic architecture comprises a server 12 in communication with a controller switch 14, which are both preferably located within an electronics equipment bay 16 of an aircraft and controlled by a control panel 30 and master power switch 32 in a cabin environment 34. Generally, the server 12 transmits, receives, and stores in-flight entertainment data that is provided to a plurality of passenger seats 18. Further, the controller switch 14 controls the transmission of in-flight entertainment data to the plurality of passenger seats 18, preferably as a part of an in-seat area, among other components of an in-flight entertainment system as described in greater detail below.

Although the detailed description herein is directed to an in-flight entertainment system delivering in-flight entertainment data to passenger seats on commercial aircraft, the invention is also applicable to other modes of mass transit such as ship, train, bus, and others, and the reference to aircraft should not be construed as limiting the scope of the present invention. Accordingly, in-flight entertainment is also referred to as mobile entertainment to encompass other modes of transportation to which the present invention may be applied.

As further illustrated, the electronic architecture 10 further communicates with other components of an in-flight entertainment system that may include, for example, an overhead/underfloor distribution area 20, an overhead video area 22, wall mounts or monuments 24 (e.g., telephones, monitors), an underseat group area 26, and a seat arm area 28. The overhead/underfloor distribution area 20 generally functions to distribute seat power, seat wireless or fiber optic interfaces, panel wireless or fiber optic interfaces, and wall mount or monument interfaces. Further, the underseat group area 26 also provides power distribution.

The overhead video area 22 generally comprises tapping units, video display units, LCD (liquid crystal display) displays, and large displays. Additionally, the seat arm area 28 comprises interfaces for headphones, telephones, PC power, and volume/channel selection controls, among others. Preferably, the in-seat areas of the passenger seats 18 comprise an LCD display, multimedia decoding, seat multiplexing, default data storage, and wireless receive and transmit provisions, among others. Additional components of an in-flight entertainment system may also be provided that are in communication with the electronic architecture 10 of the present invention. Accordingly, the in-flight entertainment system components as described herein are merely exemplary and shall not be construed as limiting the scope of the present invention.

In operation, the server 12 executes functional elements through software that include, for example, audio, video, and data storage, web caching and storage, component mapping, CD and DVD players, and pre-recorded announcement machine boarding music, among others. Furthermore, the in-flight entertainment data is preferably distributed via a wireless interface to the passenger seats 18 and to other components of the in-flight entertainment system. However, other methods commonly known in the arts such as hardwiring or optical fibers, among others, may also be employed to transmit in-flight entertainment data in accordance with the teachings of the present invention.

The server 12 is located within the electronics equipment bay 16, or a crown area, rather than within purser work stations or video control centers of existing aircraft, thereby creating more space for additional seats or passenger comfort features. Additionally, the functional elements are executed by software, rather than within individual electronic boxes or hardware, which results in significant cost and weight savings, in addition to reduced power and cooling requirements. Moreover, the electronic architecture 10 is easily upgradeable through the software and is further plug and play compatible.

The controller switch 14 is also preferably located within the electronics equipment bay 16 along with the server 12 and similarly executes data functions through software. The data functions may include, for example, transmit and receive to and from a plurality of users, built in test equipment dataload, satellite data interface, multiplexing, mapping, zone standard client support service interface, packet switching system data processing, multimedia routing, and avionics data standard interface, among others. Therefore, the controller switch 14 controls the transmission of in-flight entertainment data to the plurality of passenger seats 18 and to other components of the in-flight entertainment system.

Accordingly, the electronic architecture 10 of the present invention facilitates a consolidated in-flight entertainment system that reduces space and cost, and which further reduces power and cooling requirements onboard commercial aircraft. Further, the electronic architecture allows for plug and play compatibility in addition to ease of upgrades, which results in significant cost savings for an in-flight entertainment system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronic architecture for mobile entertainment systems comprising:
a server that receives, transmits, and stores mobile entertainment data; and
a controller switch in communication with the server that controls the transmission of mobile entertainment data to a plurality of components,
wherein a plurality of functional elements are executed by the server and data functions are executed by the controller switch through software.

2. The electronic architecture of claim 1, wherein the mobile platform is an aircraft and the server is located in an electronics equipment bay of the aircraft.

3. The electronic architecture of claim 1, wherein the functional elements further comprise audio, video, and data storage.

4. The electronic architecture of claim 1, wherein the functional elements further comprise web caching and storage.

5. The electronic architecture of claim 1, wherein the functional elements further comprise component mapping.

6. The electronic architecture of claim 1, wherein the functional elements further comprise CD and DVD players.

7. The electronic architecture of claim 1, wherein the functional elements further comprise pre-recorded announcement machine boarding music.

8. The electronic architecture of claim 1, wherein the functional elements further comprise telephone system communications.

9. The electronic architecture of claim 1, wherein the controller switch performs data functions selected from a group consisting of transmit and receive to and from a plurality of components, built in test equipment dataload, satellite data interface, multiplexing, mapping, zone standard client support service interface, packet switching system data processing, multimedia routing, or avionics data standard interface.

10. The electronic architecture of claim 1, wherein the components further comprise passenger seats.

11. The electronic architecture of claim 1, wherein the transmission of mobile entertainment data is wireless.

12. The electronic architecture of claim 1, wherein the mobile entertainment data is in-flight entertainment data.

13. A method of managing mobile entertainment data, the method comprising the steps of:
(a) receiving, transmitting, and storing mobile entertainment data on a server that executes functional elements within an electronics equipment bay of a mobile platform;
(b) establishing communication between the server and a controller switch that that controls the transmission of mobile entertainment data to a plurality of passenger seats on a mobile platform;
(d) distributing mobile entertainment data to and from the controller switch to and from the plurality of passenger seats.

14. The method of claim 13, wherein the mobile platform is an aircraft.

15. The method of claim 13, wherein the functional elements are selected from a group consisting of audio, video, and data storage, web caching and storage, component mapping, CD and DVD players, or pre-recorded announcement machine boarding music.

16. The method of claim 13, wherein the controller switch performs functions selected from a group consisting of transmit and receive to and from a plurality of users, built in test equipment dataload, satellite data interface, multiplexing, mapping, zone standard client support service interface, packet switching system data processing, multimedia routing, or avionics data standard interface.

17. The method of claim 13, wherein the distribution of mobile entertainment data is wireless.

18. The method of claim 13, wherein the mobile entertainment data is in-flight entertainment data.

19. An electronic architecture for in-flight entertainment systems comprising:
a server located within an electronics equipment bay of an aircraft that receives, transmits, and stores in-flight entertainment data; and
a controller switch in communication with the server that controls the transmission of in-flight entertainment data to a plurality of passenger seats in the aircraft,
wherein a plurality of functional elements are executed by the server and data functions are executed by the controller switch through software.

20. The electronic architecture of claim 19, wherein the transmission of in-flight entertainment data is wireless.
